(19) United States
(12) Patent Application Publication
(10) Pub. No.: US 2009/0319328 A1
(43) Pub. Date: Dec. 24, 2009

(54) METHOD AND APPARATUS FOR PERSONAL INFORMATION MANAGEMENT USING SENSORY INFORMATION

(76) Inventors: Ki-Uk Kyung, Daejeon (KR); Ji-Eun Park, Seoul (KR); Jun-Seok Park, Daejeon (KR); Dong-Won Han, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/442,220

(22) PCT Filed: Aug. 31, 2007
(86) PCT No.: PCT/KR07/04207

§ 371 Date: Mar. 20, 2009

(30) Foreign Application Priority Data
Sep. 29, 2006 (KR) 10-2006-0096580

(51) Int. Cl. G06Q 10/00; G06F 17/30; G04B 47/00

(52) U.S. Cl. 705/9; 707/100; 368/10; 707/E17.044

(57) ABSTRACT

In order to manage personal information, a schedule information collector to receive items relating to a schedule of a user's and to distinguish the received items to generate first schedule data; a schedule data processor to add sensory information corresponding to the respective items of the first schedule data to generate second schedule data; and a schedule notifier to notify the sensory information of the second schedule data, in which time when the second schedule data is notified to the user is arrived, to the user.

### TECHNICAL FIELD

The present invention relates to a personal information management, and more particularly, to a personal information managing apparatus using sensory information to transmit notice information about a schedule to a user using a sensible device sensed by the user and a method thereof.

### BACKGROUND ART

People who live in modern society directly or indirectly contact so many people as communication devices such as traffic, telephones, mail, internet, and the like is developed. In this circumstance, so many events occur. Moreover, modern people, who meet a variety of information directly or indirectly related to themselves every day, need a lot of time and effort to extract only information related to themselves from a great deal of information and to put the information to practical use at proper time and at a proper situation. Thus, trials and desires that systematically manage and utilize such events and information to improve more effective time management and are practical for life are gradually increased.

In general, for the management of schedule, a user uses an electronic organizer (a digital organizer), a personal digital assistant (hereinafter, referred to as a ‘PDA’, a scheduler installed in a mobile communication phone, or the like. In the PDA and portable IT office equipment, a schedule organizer and an application program to provide an alarming signal are mostly used. However, the contemporary alarming device plays only a role of indicating a schedule to be practiced by vibration signal and the same or similar sound or vibration signal is used to indicate every schedule, therefore the user must remember the contents of the schedule.

### DISCLOSURE OF INVENTION

### Technical Problem

Therefore, the present invention has been made in view of the above problems, and it is an aspect of the present invention to provide an apparatus to notify various personal schedule information to a user to intuitively recognize the schedule information and a method thereof.

### Technical Solution

In accordance with an aspect of the present invention, the above and other aspects can be accomplished by the provision of a personal information managing apparatus using sensory information, including: a schedule information collector to receive items relating to a schedule of a user's and to distinguish the received items to generate first schedule data; a schedule data processor to add sensory information corresponding to the respective items of the first schedule data to generate second schedule data; and a schedule notifier to notify the sensory information of the second schedule data, in which time when the second schedule data is notified to the user is arrived, to the user.

In this case, the personal information managing apparatus further includes a schedule managing database to store category information about the items of the schedule of the user's and sensory information corresponding to the category information.

Another aspect of the present invention can be accomplished by the provision of a personal information managing method using sensory information including: inputting items relating to a schedule of a user's by the user; arranging the inputted schedule according to the items to generate first schedule data; adding sensory information corresponding to the items of the first schedule data to generate second schedule data; and notifying a corresponding schedule to the user by providing the sensory information of the second schedule data with respect to the schedule when a time when the schedule is notified to the user is arrived.

### Advantageous Effects

As described above, according to the personal information managing apparatus using sensory information and a method thereof according to the present invention, various personal schedule information can be notified to the user to intuitively recognize the content of the schedule through his/her sensory organs.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram schematically illustrating a system to manage personal information of a user's using a personal information managing apparatus using sensory information according to an embodiment of the present invention;

FIG. 2 is a block diagram schematically illustrating the personal information managing apparatus using the sensory information according to another embodiment of the present invention;

FIG. 3 is flowchart schematically illustrating a processing flow of a personal information managing method according to an embodiment of the present invention;

FIG. 4 is a flowchart illustrating a flow of providing a corresponding schedule in still another embodiment of the present invention; and

FIG. 5 is a view illustrating a process of managing the personal schedule by applying the personal schedule managing apparatus according to still another embodiment of the present invention to the personal information terminal or a pen-type notifier.

### BEST MODE FOR CARRYING OUT THE INVENTION

Hereinafter, the embodiments of the present invention will be described in detail with reference to accompanying drawings such that those skilled in the art may fully understand the concept of the present invention. In the following description of the present invention, if it is determined that the detailed description of already known components or functions related to the present invention may confuse the subject matter of the present invention, the detailed description will be omitted.

Moreover, it is noted that although similar components are depicted in different drawings, same reference numerals are assigned to the similar components if possible.

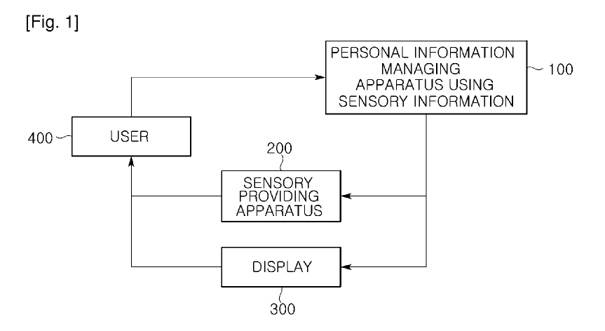

FIG. 1 is a block diagram schematically illustrating a system to manage personal information of a user's using a personal information managing apparatus using sensory information according to an embodiment of the present invention. Needless to say, although the system may further include other components, FIG. 1 illustrates only necessary components for the illustrative purpose.

Referring to FIG. 1, the system includes a user 400, a personal information managing apparatus 100 using sensor information, a sensory providing apparatus 200, and a display 300.

The user 400 inputs his/her schedule using the entire system to manage his/her personal information and is provided with notifying information about the inputted schedule when the user sets a notifying time through various sensory organs. To this end, the user 400 inputs his/her personal schedule to the personal information managing apparatus 100 using the sensory information together with inputting a specific time when the inputted schedule is notified. In this embodiment, the user 400 may further input information about time, content, and importance of the schedule, a place, together with at least one of information such as whether to be repeated, participants, and a schedule type to the personal information managing apparatus 100.

In this embodiment of the present invention, the personal information managing apparatus 100 makes respective items of the schedule into a category and may provide a circumstance in such a way in which the user 400 selects the category of the respective items. For example, with respect to an item of the schedule type, ‘PERSONAL’ or ‘OFFICIAL’ may be made in the category, an item with respect to the content of the schedule may be categorized by ‘MEETING’, ‘BUSINESS TRIP’ or ‘BRIEFING’ and an item with respect to the importance of the schedule may be categorized by ‘HIGH’, ‘MEDIUM’ and ‘LOW’.

The personal information managing apparatus 100 generates first schedule data based on the schedule inputted by the user 400 and combines sensory information corresponding to the contents of the respective items of the first schedule data with the first schedule data to produce second schedule data. Here, the first schedule data and the second schedule data are mentioned in this description to distinguish a data format of the schedule data and are distinguished according to whether the sensory information corresponding to the respective items of the schedule data is contained or not. In other words, the first schedule data is schedule data in which only information about the schedule inputted by the user is arranged by the items, and the second schedule data is processed data in which the sensory information corresponding to information corresponding to the respective items of the data based on the first schedule data is contained in the first schedule data.

In this embodiment of the present invention, the personal information managing apparatus preferably stores category information about the respective contents of the schedule items related to the first schedule data and the sensor information corresponding to the contents of the items of the first schedule data related to the second schedule data.

Moreover, the personal information managing apparatus 100 provides information to the user 400 in the sensible form based on the second schedule data when the schedule is notified to the user 400. To this end, the personal information managing apparatus 100 displays the schedule data corresponding to visual sensory information using the display 300 based on the sensory information that is stored in the second schedule data, and delivers the schedule data corresponding to the sensory information other than the visual sensory information through the sensory providing apparatus 200. In this case, the time point when the schedule is notified to the user 400 is preferably a time related to a schedule contained in the schedule data that is inputted by the user 400 or is determined based on a schedule provision time that is inputted by the user.

The sensory providing apparatus 200 is an apparatus to implement the schedule data corresponding to one or more sensory information that is selected from aural sense, tactual sense, olfactory sense, and gustatory sense except for the visual sensation and deliver the implemented sensory information to the user to sense the same through his/her sensory organs. The sensory providing apparatus employed in the present invention may be selected from all sensory providing apparatus, already known to the skilled in the art, to provide to the user one or more sensory information that is selected from aural sense, tactual sense, olfactory sense, and gustatory sense by a command of the personal information managing apparatus 100 according to the determination of those skilled in the art.

Here, the personal information managing apparatus 100 can carry out information interchange with the sensory providing apparatus 200 via a wired network or a wireless network, and the display 300 provides the schedule data corresponding to the visual sensory information according to the request from the personal information managing apparatus 100. In this embodiment of the present invention, the display 300 may be a monitor of a computer, a screen of the PDA, or a screen of a mobile communication terminal.

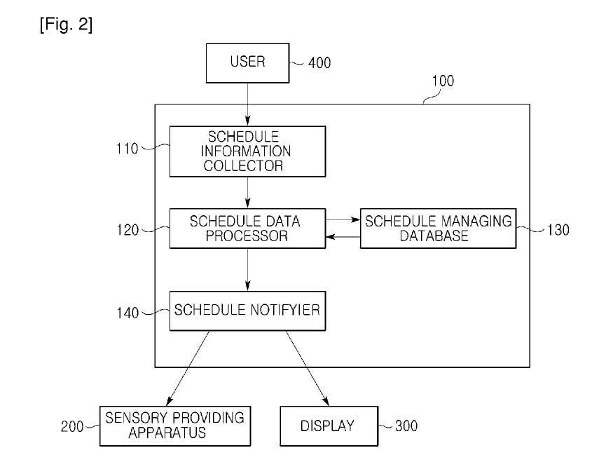

FIG. 2 is a block diagram schematically illustrating a personal information managing apparatus using sensory information according to another embodiment of the present invention. Hereinafter, the personal information managing apparatus using the sensory information according to another embodiment of the present invention will be described in detail with reference to FIG. 2.

Referring to FIG. 2, the personal information managing apparatus using sensory information according to another embodiment of the present invention includes a schedule information collector 110, a schedule data processor 120, a schedule managing database 130, and a schedule notifier 140.

The schedule information collector 110 receives items related to the schedule of the user from the user and produces first schedule data. To this end, the schedule information collector 110 can manage the inputted schedule information using the schedule data table to distinguish various information about the schedule according to the items. In other words, when information about time, contents, and importance of the schedule and one or more information that is selected from a place relating to the schedule, whether the schedule is repeated or not, attendances, and types of the schedule are inputted, the information is allocated to the item corresponding to the schedule data table such that the first schedule data about the schedule is generated.

In this embodiment of the present invention, the schedule information collector 110 provides the items previously categorized with respect to the schedule based on the information stored in the schedule managing database 140 to the user, and provides a circumstance in which the schedule is inputted such that the user selects the category according to the items.

The schedule data processor 120 receives the first schedule data of the user from the schedule information collector 110, and processes the second schedule data by combining the sensory information corresponding to the respective items information of the schedule data with the schedule data. In this embodiment, the schedule data processor 120 selects the sensory information corresponding to the respective item information of the first schedule data based on the information stored in the schedule managing database 130 and adds the selected sensory information to an item corresponding to the first schedule data to process the second schedule data.

The sensory information corresponding to the item information means the sensory information relating to the visual sense, aural sense, tactual sense, olfactory sense, or the gustatory sense to help the user to remember the information about the corresponding item. Thus, in the present invention, the relationship between the item information and the sensory information is a relative relationship that may be changed according to users, but must not be an absolute relationship, can be easily selected by those skilled in the art, and can be modified by the user. For example, when the content of the item ‘TYPE OF SCHEDULE’ of the first schedule data is ‘MEETING’, the sensory information such as a visual image matched to a meeting such as an icon of a conference table, a sound of reminding a meeting, a tactual stimulating pattern of reminding a meeting, and aroma of reminding a meeting such as coffee aroma is added as the sensory information corresponding to the item ‘MEETING’.

The schedule managing database 130 stores the category information of items required to manage the schedule of the user and the sensory information corresponding to the category information. To this end, the schedule managing database 130 stores the information corresponding to the contents of the respective items of the schedule data table managed by the schedule information collector 110 in the form of previously categorized information, stores the sensory information corresponding to the categorized information by previously setting the sensory information. In this embodiment of the present invention, the schedule managing database 130 preferably stores information that is previously set in correspondence to the category information, the schedule information inputted by the user, and the sensory information corresponding to the information.

The schedule notifier 140 notifies the schedule to be set to notify to the user. In this case, the schedule notifier 140 notifies the sensory information set in correspondence to the second schedule data through a corresponding sensory organ, and preferably, notifies the schedule data corresponding to the visual sensory information among the contents about the schedule and the schedule data corresponding to the sensory information except for the visual information to the user by distinguishing the information. In other words, an item of which the contents about the second schedule data that the user can confirm visually is notified to the user through the display such as a liquid crystal display to process visual information, an item of which the contents about the second schedule data that is confirmed by sensation such as the olfactory sense, the tactual sense, and the gustatory sense other than the visual sensation is notified to the user through a device to implement the sensory information.

A time point when the schedule notifier 140 notifies the schedule to the user is preferably determined based on the schedule data that the schedule information collector 110 receives.

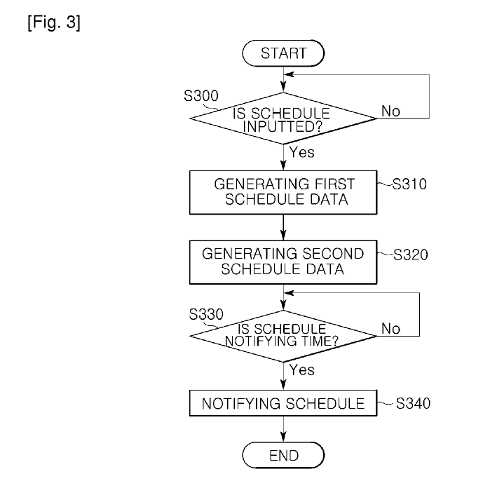

FIG. 3 is flowchart schematically illustrating a processing flow of a personal information managing method according to an embodiment of the present invention. Hereinafter, the personal information managing method according to the present invention will be described in detail with reference to FIG. 3.

Firstly, the user inputs items relating to the scheduled (S300). In this case, the inputted items relating to the schedule may contain information such as time, content, and importance of the schedule as well as one or more information selected from a place, whether the schedule is repeated or not, attendances, type of the schedule, and the like. In this embodiment of the present invention, when the items about the schedule is inputted in the process S300, basic contents corresponding to the respective items are categorized and provided to the user to select the same, and other items that are not categorized can be inputted directly by the user. When the user directly inputs the items, the sensory information corresponding to the matched contents is preferably inputted.

If the items relating to the schedule are inputted in the process S300, the first schedule data is generated based on the inputted items (S310). In this case, the first schedule data is data in which only information about the schedule inputted by the user is arranged according to the items, and is schedule data different from the second schedule data described later.

When the first schedule data is generated in the process S310, the second schedule data is generated based on the first schedule data (S320). To this end, the sensory information corresponding to information corresponding to the respective items of the first schedule data generated as described above is combined with the first schedule data to process the second schedule data.

Next, whether time when the corresponding schedule has to be notified to the user is arrived or not is checked (S330). The time when the schedule is notified to the user is preferably determined at time relating to the schedule contained in the schedule data that is inputted by the user or at a provided time inputted by the user.

If time when the corresponding schedule must be notified to the user is arrived by the process S330, the corresponding schedule is notified to the user based on the second schedule data generated in the process S320 (S340). At that time, the visual information and other information of the second schedule data are distinguished and notified to the user in different methods. In other words, the items that the user can perceive with his/her eyes are notified to the user through the display such as the LCD monitor to process the visual information, and other items that the user can confirm through his/her senses such as the aural sense, the tactual sense, the olfactory sense, or the gustatory sense other than the visual sense which are notified to the user through a device to implement the sensory information.

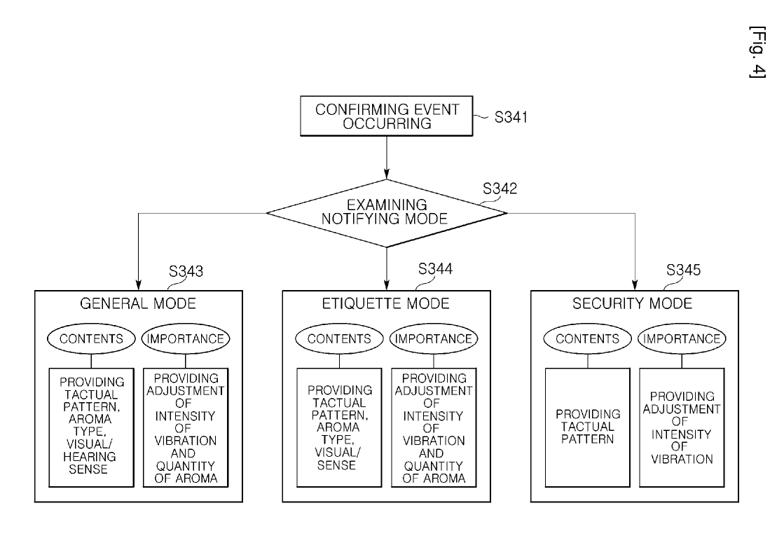

Hereinafter, the process of providing the corresponding schedule to the user in the process S340 depicted in FIG. 3 will be described in detail with reference to FIG. 4.

FIG. 4 is a flowchart illustrating a flow of the process of providing the corresponding schedule in still another embodiment of the present invention.

Firstly, whether a schedule to be notified to the user is generated or not is checked (S341). The method of checking whether the schedule occurs or not is determined based on time relating to the schedule contained in the schedule data inputted by the user or the provided time directly inputted by the user.

Next, if that the schedule to be notified to the user occurs is checked in the process S341, a setting circumstance how a notifying mode of the personal information managing apparatus using sensory information according to the present invention is set is examined (S342). The notifying mode is to set an operating range of a function of notifying the schedule to the user in the personal information managing apparatus using sensory information according to the present invention, and is a reference previously determined to notify the schedule to what range according to a relationship between the user of the personal information managing apparatus and the surrounding circumstance of the user.

FIG. 4 provides three modes such as a general mode, an etiquette mode, and a security mode of providing the corresponding schedule in this embodiment of the present invention. However, this is an example of the modes that can be set in the personal schedule managing method according to the present invention, and the type of the mode is not limited.

In FIG. 4, the general mode means that the operating range of the schedule notifying function has no limit. The etiquette mode means that the operating range of the schedule notifying function is restricted to the user such that other persons surrounding the user cannot perceive the schedule notifying function but another person, surrounding the user, who has an interest in the schedule notifying function, can perceive the schedule notifying function. The security mode means that the operating range of the schedule notifying function is restricted to the user and other persons surrounding the user cannot perceive the schedule notifying function as well as another person, surrounding the user, who has an interest in the schedule notifying function, cannot perceive the schedule notifying function.

As a result of the examination in the process S342, when the set notifying mode is the general mode, since the operating range of the schedule notifying function has no limit, the contents of the schedule is provided to the user through every possible sensation and the corresponding schedule is notified to the user by adjusting an intensity of vibration and the quantity of aroma.

When the set notifying mode is the etiquette mode as a result of the examination in the process S342, only the tactual pattern, the aroma, and the visual image are provided for the schedule notifying and the aural signal that may be transmitted to other people surrounding the user is excluded. Since the aroma does not decentralize people s attention in comparison to the visual sensation and the hearing sense, the aroma can be used in the etiquette mode. Thus, in the importance item, the adjustment of the intensity of the vibration and the quantity of the aroma can be used as they are.

When the set notifying mode is the security mode as a result of the examination in the process S342, the aural signal such as sound as well as the visual image and the aroma is excluded but the schedule content is provided by only the tactual pattern. This is because other people may perceive the contents of the schedule through sound, the visual image, and the aroma.

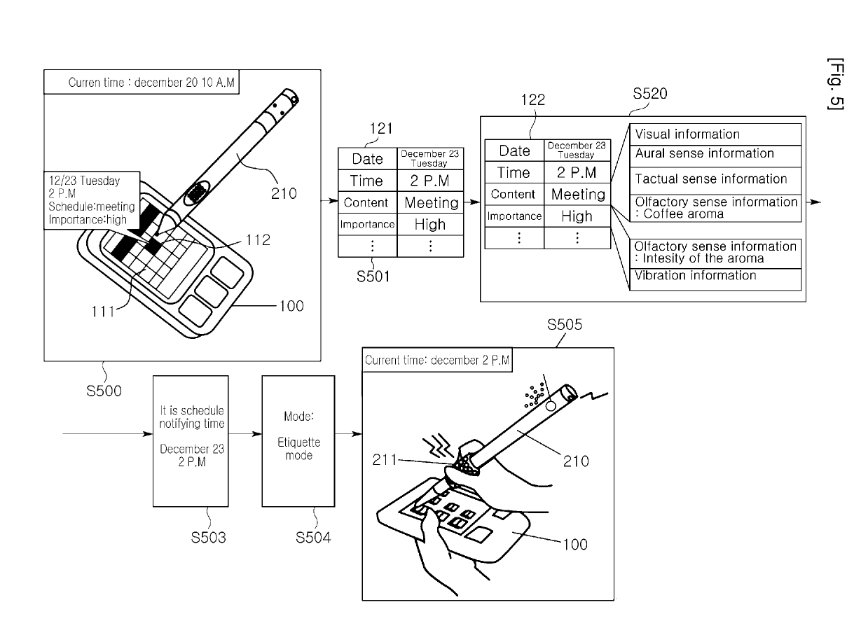

FIG. 5 is a view illustrating a process of managing the personal schedule by applying the personal schedule managing apparatus according to still another embodiment of the present invention to the personal information terminal (PDA) 100 or a pen-type notifier 210.

Firstly, the user inputs his/her schedule using a scheduler program 111 installed in the PDA 100. As illustrated in FIG. 5, the user inputs a schedule of a meeting on December 23, at 2 P.M. and sets an alarming. In more detail, the user selects December 23 from a calendar provided by the scheduler program and inputs ‘MEETING’ to a portion 112 corresponding to 2 P.M. by selecting December 23 and an item ‘MEETING’ together with the importance (S500).

Based on the information about the inputted schedule, the first schedule data 121 is generated (S501). As illustrated in FIG. 5, the first schedule data 121 contained ‘December 23’, Tuesday allocated in a date item, ‘2 P.M’. allocated in a time item, ‘MEETING’ allocated in a schedule content item, and ‘HIGH’ allocated in the importance item.

Next, based on the first schedule data 121, the second schedule data 122 is generated (S502). As illustrated in FIG. 5, with respect to the item of the schedule ‘MEETING’ the icon as the visual information of reminding the meeting, a beep sound as the aural sense information of reminding that the meeting is held at the corresponding time, the tactual pattern as the tactual sense information of reminding that the meeting is held at the corresponding time, and the coffee aroma as the olfactory sense information of reminding that the meeting is held at the corresponding time are generated as the respective sensory information. Moreover, since the importance item is ‘HIGH among ‘HIGH’, ‘MEDIUM’, and ‘LOW’ the intensity of the aroma 3, and the intensity of the vibration 3 are contained in the vibration information and the aroma information, respectively.

Next, when it is on 2 P.M. December 23 as previously set (S503), the mode of the PDA 100 is examined (S504). In this case, it is assumed that the user sets the mode of the PDA 100 to the ‘etiquette mode’ because the user has a meeting to be held from 1 P.M. December 23. Thus, since the mode of the PDA 100 is set to the etiquette mode as a result of the examination, a tactual sense implementing device 211 of the pen-type notifier 210 provides the tactual pattern, an aroma implementing device 212 provides coffee aroma, and the visual image is provided through the screen of the PDA 100 to provide the schedule, and the PDA 100 notifies the schedule to the user with the intensity of the vibration 3 and the intensity of the frequency or the aroma 3 (S505).

The tactual implementing device 211 includes an arrangement of a plurality of actuators arranged in a predetermined pattern and can implement the tactual pattern by controlling the respective actuators. For example, nine actuators arranged in a way of three columns by three rows individually actuate to implement the tactual pattern in a specific form of reminding the user of the contents of the schedule. The individual actuators may be a small size vibration motor, a small size pin-shaped linear motor to directly stimulate the user's skin in the vertical direction, or various electric-reactive materials such as a solenoid, a piezoelectric actuator, a piezoelectric polymer, and the like. Using this principle, when the user carries the tactual providing apparatus 210 such as a pen-type notifier to write texts or to point any place in a conference hall, the user can receive the schedule information through his/her tactual senses without the visual and aural senses. Here, a vibration device to transmit the importance of the schedule may be implemented by a vibration motor employed in the tactual sense implementing device 211 or by installing a vibration motor in the tactual providing apparatus 210.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Modifications and equivalents will be apparent to those skilled in the art and are encompassed within the spirit and scope of the appended claims.

1. A personal information managing apparatus using sensory information, comprising:
a schedule information collector to receive items relating to a schedule of a user's and to distinguish the received items to generate first schedule data;
a schedule data processor to add sensory information corresponding to the respective items of the first schedule data to generate second schedule data; and
a schedule notifier to notify the sensory information of the second schedule data, in which time when the second schedule data is notified to the user is arrived, to the user.

2. The personal information managing apparatus using sensory information according to claim 1, further comprising a schedule managing database to store category information about the items of the schedule of the user s and sensory information corresponding to the category information.

3. The personal information managing apparatus using sensory information according to claims 1 or 2, wherein the first schedule data contains time, content, and an importance of the schedule.

4. The personal information managing apparatus using sensory information according to claim 3, wherein the first schedule data contains one or more information selected from a place relating to the schedule, whether the schedule is repeated or not, attendants, and a type of the schedule.

5. The personal information managing apparatus using sensory information according to claim 2, wherein the schedule information collector provides the user items previously categorized with respect to the schedule based on the information stored in the schedule managing database and provides an input circumstance in which the user selects the categorized items to input schedule.

6. The personal information managing apparatus using sensory information according to claim 2, wherein the schedule managing database stores schedule information inputted by the user and the sensory information corresponding to the schedule information.

7. The personal information managing apparatus using sensory information according to claim 1, wherein the schedule notifier notifies an item of the second schedule data that the user can perceive with his/her eyes to the user through a display to process visual information, and another items of the second data that the user can perceive with sensory organs other than the eyes to the user through a device to implement the sensory information.

8. The personal information managing apparatus using sensory information according to claim 1, wherein a time point when the schedule notifier notifies the schedule to the user is determined based on schedule data inputted to the schedule information collector.

9. A personal portable terminal comprising the personal information managing apparatus using sensory information according to claims 1 or 2.

10. A personal information managing method using sensory information comprising:
inputting items relating to a schedule of a user s by the user;
arranging the inputted schedule according to the items to generate first schedule data;
adding sensory information corresponding to the items of the first schedule data to generate second schedule data; and
notifying a corresponding schedule to the user by providing the sensory information of the second schedule data with respect to the schedule when a time when the schedule is notified to the user is arrived.

11. The personal information managing method using sensory information according to claim 10, wherein the items inputted in the inputting comprises information about time, content, and an importance of the schedule, and one or more information selected from a place of the schedule, whether the schedule is repeated or not, attendants, and a type of the schedule.

12. The personal information managing method using sensory information according to claim 10, wherein the inputting items relating to the schedule comprises categorizing basic contents corresponding to the respective items to be provided to the user such that the user can select the categorized contents.

13. The personal information managing method using sensory information according to claim 12, wherein the inputting items relating to the schedule comprises:
inputting an item that is not contained in the category directly by the user; and
inputting sensory information corresponding to a corresponding contents.

14. The personal information managing method using sensory information according to claim 10, wherein the time when the schedule is notified to the user in the notifying is determined by time relating to the schedule contained in the schedule data that is inputted by the user or a providing time inputted by the user.

15. The personal information managing method using sensory information according to claim 10, wherein the notifying a corresponding schedule to the user comprises:
notifying an item of the second schedule data that the user can perceive with his/her eyes to the user through a display to process visual information; and
notifying items of the second schedule data that the user can perceive with his/her sensory organs other than the visual sensation to the user through a device to implement the sensory information.

16. The personal information managing method using sensory information according to claim 10, further comprising examining a setting circumstance how a notifying mode of a personal information managing device using sensory information is set before notifying a corresponding schedule information to the user when the time when the schedule is notified to the user is arrived in the notifying.
